(19) United States
(12) Patent Application Publication
(10) Pub. No.: US 2013/0144827 A1
(43) Pub. Date: Jun. 6, 2013

(54) SYSTEMS AND METHODS FOR SUPPORTING FERTILIZER DECISIONS

(71) Applicant: SCHAFFERT MANUFACTURING COMPANY, INC, Indianola, NE (US)

(72) Inventors: Ramiro Trevino, Indianola, NE (US); Matthew Thomas O'Donnell, Snohomish, WA (US); Brian Frank O'Donnell, Seattle, WA (US)

(73) Assignee: SCHAFFERT MANUFACTURING COMPANY, INC., Indianola, NE (US)

(21) Appl. No.: 13/757,106

(22) Filed: Feb. 1, 2013

Related U.S. Application Data
(63) Continuation-in-part of application No. 13/365,015, filed on Feb. 2, 2012.
Application No. 13/365,015 is a continuation-in-part of application No. PCT/US2012/023676, filed on Feb. 2, 2012.
(60) Provisional application No. 61/745,367, filed on Dec. 21, 2012.
(60) Provisional application No. 61/693,614, filed on Aug. 27, 2012.
(60) Provisional application No. 61/439,249, filed on Feb. 3, 2011.
(60) Provisional application No. 61/569,199, filed on Dec. 9, 2011.
(60) Provisional application No. 61/439,249, filed on Feb. 3, 2011.
(60) Provisional application No. 61/569,199, filed on Dec. 9, 2011.

(51) Int. Cl. G06N 5/02; G01F 1/00

(52) U.S. Cl. CPC G06N 5/02; G01F 1/00
USPC 706/46; 73/861

(57) ABSTRACT

Systems and methods for supporting fertilizer decisions are provided. The systems and methods may be configured to receive data relating to the application of a liquid fertilizer to a field having a number of rows. The data may include at least one fertilizer characteristic and yield data relating to each row of the number of rows. The systems and methods may be configured to receive a request from a user to analyze the data. The systems and methods may be configured to compare the at least one fertilizer characteristic and the yield data for each row of the number of rows. The systems and methods may be configured to communicate the results of the comparison to the user.

### CROSS-REFERENCE TO RELATED APPLICATIONS

This application claims the benefit under 35 U.S.C. §119(e) of U.S. Provisional Patent Application No. 61/745,367, filed Dec. 21, 2012, and entitled “Intelligent Pump System”; and of U.S. Provisional Patent Application No. 61/693,614, filed Aug. 27, 2012, and entitled “Intelligent Pump System.”

This application also is a continuation-in-part of U.S. patent application Ser. No. 13/365,015, filed Feb. 2, 2012, and entitled “Liquid Fertilizer Sensor System,” and of International Application No. PCT/US2012/023676, filed Feb. 2, 2012, and entitled “Liquid Fertilizer Sensor System,” both of which claim the benefit under 35 U.S.C. §119(e) of U.S. Provisional Patent Application No. 61/569,199, filed Dec. 9, 2011, and entitled “Intelligent Pump System,” and U.S. Provisional Patent Application No. 61/439,249, filed Feb. 3, 2011, and entitled “Liquid Fertilizer Sensor System.”

All of the aforementioned applications are hereby incorporated by reference herein in their entireties.

### TECHNICAL FIELD

The technical field relates generally to agricultural planting equipment, and more specifically to fertilization and monitoring systems for planting equipment.

### BACKGROUND

Mechanical seed planting devices are used to plant seeds in large areas, for example farms having over an acre. Planting devices are often pulled by a tractor and may include multiple planting units. Each planting unit holds seeds and may include a device to create a furrow in the ground as the tractor moves forward. When the furrow is created, a seed is deposited into the ground via a seed dispensing apparatus. Farmers often want to fertilizer the seed within the furrow at the time the seed is deposited. In these cases, the planting machine may include a fertilizer unit along with the planting unit. The fertilizer unit deposits fertilizer in the furrow along with the seed as the tractor moves. Problems arise if too much or too little fertilizer is included along with the seed. Too much fertilizer and the seed may die, grow too rapidly or otherwise be unhealthy. Similarly, too little fertilizer and the seed may not germinate. Current fertilizer systems do not accurately monitor the fertilizer dispensed into each furrow or allow for easy adjustment of the fertilizer levels deposited, and current systems may not detect whether liquid is flowing at all. Further, existing fertilizer systems may rely on the pump performance to regulate and control fertilizer flow, which may not always be an accurate measure.

### SUMMARY

Some embodiments of a fertilizer apparatus may include a fluid bar configured to be towed by a tractor or other vehicle. The fluid bar may be fluidly connected to a fertilizer source. The fluid bar may contain a fluid passageway in fluid communication with apertures for dispensing the fertilizer. There may be sensors for monitoring the fluid flow through the apertures. The sensor information may be utilized to determine a fluid flow rate through the apertures. The apparatus may also include a sensor monitor that displays the flow rate as detected by the sensors. The apparatus may further include a pump that is configured to pump fertilizer from the fertilizer source to the passageway. Additionally, the system may include a pump controller to adjust the pump flow rate.

Some embodiments of a liquid fertilizer dispensing system may include a tractor, a fertilizer bar configured to be attached to the tractor, and monitoring equipment. The fertilizer bar may include a fluid passageway, at least one outlet for the passageway, a sensor for each outlet, a tank for storing fertilizer or other liquids, and a pump for pumping the fertilizer or liquid from the tank to the fluid passageway. The monitoring equipment may include a sensor monitor to display the flow rate of the fertilizer or liquid through the outlet as measured by the sensors. There may be multiple outlets, and each outlet may include a sensor. Additionally, the system may include a pump controller for adjusting the pump rate of the pump. The monitoring display and the pump controller may be located within a cab of the tractor.

Some embodiments of a liquid flow metering system may include a reservoir, a pump, multiple fluid outlets, multiple sensors, a hardware control, and a software control unit. The reservoir may be configured to store a liquid. The pump may be in fluid communication with the fertilizer reservoir and the multiple fluid outlets. The multiple fluid outlet may be configured to deliver to a desired area liquid received from the reservoir via the pump. The multiple sensors may be configured to monitor a flow rate of the liquid to each of the multiple fluid outlets. Each of the multiple sensors may be operatively associated with the hardware control. The hardware control may be operatively associated with a software control unit.

Some embodiments of a decision support system may include a data aggregator, an analysis engine, and an output generator. The data aggregator may be configured to receive, from an electronic device, data relating to the application of a liquid (such as a fertilizer) to a field having a number of rows. The data may include at least one fertilizer characteristic and crop or yield data relating to each row of the number of rows. In addition or alternatively, the data aggregator may be configured to receive third-party data. The analysis engine may be in communication with the data aggregator and may be configured to compare the at least one fertilizer characteristic and the crop or yield data for each row of the number of rows. The output or report generator may be in communication with the analysis engine and may be configured to communicate the results of the comparison to a user.

The data aggregator, the analysis engine, and the output generator may be hardware, software configured to be executed by a processor, or a combination of both. The system may include memory configured to receive the at least one fertilizer characteristic and the yield data from the data aggregator and may store the at least one fertilizer characteristic and the yield data. A processor may be in communication with the memory.

In some embodiments, the at least one fertilizer characteristic may include a composition, a flow rate, a pressure, a temperature, any other suitable characteristic of a liquid fertilizer, or a combination thereof. In addition or alternatively to the at least one fertilizer characteristic and the crop or yield data, the data may include tractor speed data relating to each row of a number of rows in a field, seed data relating to each row of a number of rows in a field, soil data relating to each row of a number of rows in a field, and weather data relating to each row of a number of rows in a field.

In some embodiments, the analysis engine may be configured to compare at least one fertilizer characteristics, crop or yield data, tractor speed data, seed data, soil data, weather data, third-party data for each row of a number of rows in a field. The output or report generator may be configured to format or manipulate the data according to a user's request. For example, the output or report generator may be configured to format results of the analysis engine (such as a comparison) as a chart or a graph (such as an overlay), a table, a report, or a combination thereof. A report may be configured to comply with governmental reporting requirements.

Some embodiments of a method for supporting fertilizer decisions may include receiving, from an electronic device, data relating to the application of a liquid (such as a fertilizer) to a field having a number of rows. The data may include at least one fertilizer characteristic and crop or yield data relating to each row of the number of rows. The method may include receiving, from an electronic device, a request from a user to analyze the data. The method may include comparing, by a processor, the at least one fertilizer characteristic and the crop or yield data for each row of the number of rows. The method may include communicating the results of the comparison to the user. The at least one fertilizer characteristic may include a composition, a flow rate, a pressure, a temperature, any other suitable characteristic of the liquid fertilizer, or a combination thereof. In addition or alternatively to the at least one fertilizer characteristic and the crop or yield data, the data may include tractor speed data relating to each row of a number of rows in a field, seed data relating to each row of a number of rows in a field, soil data relating to each row of a number of rows in a field, and weather data relating to each row of a number of rows in a field.

In some embodiments, the method may include comparing, by a processor, at least one fertilizer characteristics, crop or yield data, tractor speed data, seed data, soil data, weather data, third-party data for each row of a number of rows in a field. The method may include formatting or manipulating the data according to a user's request. For example, the method may include formatting results of the analysis engine (such as a comparison) as a chart or a graph (such as an overlay), a table, a report, or a combination thereof. In one example, the method includes overlaying at least one fertilizer characteristic and crop or yield data for each row of a number of rows of a field. Additionally or alternatively, the method may include formatting the results of a comparison as a report complying with a governmental regulation or restriction relating to fertilizer.

Some embodiments of a fertilizer system may include a fluid bar and a plurality of sensors operably associated with the fluid bar. The fluid bar may be fluidly connected to a fertilizer source and capable of attachment to a farm machine. The fluid bar may include a fluid passageway that is in fluid communication with a plurality of apertures. Each sensor of the plurality of sensors may be configured to detect an identifying characteristic of a fluid flowing from the fluid passageway to at least one aperture of the plurality of apertures. The plurality of sensors may be configured to detect an elemental composition of the liquid, an identifier added to the fluid, or both.

In some embodiments, the fertilizer system may include a fluid reservoir in fluidic communication with the fluid bar to capture a sample of the fluid as it flows from the fluid passageway to the at least one aperture of the plurality of apertures. The fluid reservoir may include a plurality of storage cells. The fertilizer system may include a sensor monitor in communication with the plurality of sensors and configured to display for each sensor of the plurality of sensors the characteristic of the fluid measured by the sensor.

### BRIEF DESCRIPTION OF THE DRAWINGS

Exemplary embodiments are illustrated in referenced figures of the drawings. It is intended that the embodiments and figures described herein are illustrative rather than limiting. The use of the same reference numerals in different embodiments indicates similar or identical items.

FIG. 1 is a perspective view of a tractor joined to a planting bar and a fertilizer system

FIG. 2 is a block diagram of the fertilizer system, as illustrated in FIG. 1.

FIGS. 3A and 3B are enlarged views of a fertilizer bar for use with the fertilizer system.

FIG. 4 is another embodiment of the fertilizer bar including a set of seed covers attached thereto.

FIG. 5 is an embodiment of the fluid bar illustrating another embodiment of the sensor monitor.

FIG. 6 shows a schematic view of a system for monitoring the application of liquid fertilizer onto an agricultural field.

FIG. 7 shows a schematic illustration of an example architecture and design for providing information to a hosted software solution

FIG. 8 shows an example navigation map for a user interface of a software control unit.

FIG. 9 shows a potential loading screen for the user interface.

FIGS. 10A and 10B show potential dashboard screens for the user interface.

FIG. 11 shows a potential meters screen for the user interface.

FIG. 12 shows a potential meter details screen for the user interface.

FIG. 13 shows a potential settings screen for the user interface.

FIG. 14 shows a potential setting screen for the user interface.

FIG. 15 shows a potential database configuration for the software control module.

FIG. 16 is a block diagram of an example architecture for a decision support system.

FIG. 17 is a flowchart of an example operation of the decision support system, as illustrated in FIG. 16.

### DETAILED DESCRIPTION

Although one or more of the embodiments of a planting system may be described herein in detail with reference to a particular fertilizer system, the embodiments should not be interpreted or otherwise used as limiting the scope of the claims. In addition, one skilled in the art will understand that the following description has broad application. For example, while embodiments of various systems described herein may focus on fertilization of furrows, the concepts described herein equally apply to other fertilization and planting techniques, or other ways of placing liquids (such as herbicides, insecticides, or other liquids beneficial to support and enhance crop growth) on seeds, plants, or fields. Additionally, the concepts described herein may equally apply to other forms of nutrient or liquid deposit, such as watering. Furthermore, while embodiments of various systems described herein may focus on a fertilization bar, the concepts described herein equally apply to other types of mechanical fertilization equipment. For example, in some embodiments, the fertilizer system may be integral with a tractor or may be used without a tractor. Accordingly, the discussion of any embodiment is meant only to be exemplary and is not intended to suggest that the scope of the claims is limited to these embodiments.

In some embodiments, the fertilization system includes a fertilizer bar pulled by a tractor. The fertilizer bar may include multiple mounts having apertures or outlets providing a connection to hoses. Each mount may include a flow sensor. The fertilizer bar may be fluidly connected to a pump and set of filters. The may be used to transfer fertilizer from a tank to the fertilizer bar. Additionally, the fertilizer bar may include an electrical connection to one or more of a sensor monitor, a pump rate controller, and a pressure gauge. The sensor monitor, the pump rate controller and the pressure gauge may be installed within the cab of a tractor. In this implementation, the farmer may monitor from the cab each mount aperture, and consequently each hose, to confirm that the correct amount of fertilizer is deposited into each furrow and to adjust the fertilizer levels if necessary.

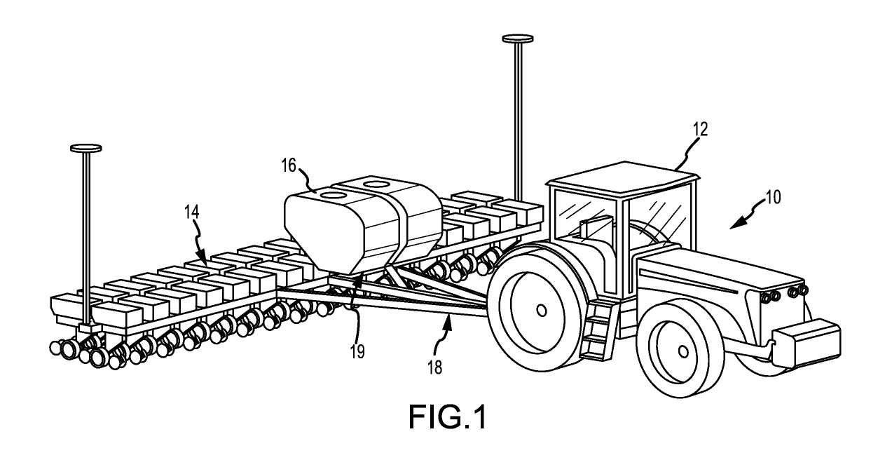

In some embodiments, the fertilizer system may be implemented within a tractor setup and include a fertilizer bar that may be pulled behind a tractor. FIG. 1 shows a schematic illustration of a tractor 10 pulling a fertilizer bar 14. The tractor 10 may be any type of tractor or other device capable of towing a bar. The tractor 10 may include a cab 12 for the farmer to sit. The cab 12 may include driving equipment, such as a steering wheel, shifter, etc., as well as other monitoring equipment, such as gas usage, speed, global positioning system, etc. The tractor 10 may connect to the fertilizer bar 14 via a hitch bar 18. The hitch bar 18 may be integrated with the fertilizer bar 14, integrated with the tractor 10, or separate from both the tractor 10 and fertilizer bar 14. The hitch bar 18, in addition to towing the fertilizer bar 14, also provides a pathway for connection wires to run between the fertilizer bar 14 and the cab 12.

The fertilizer bar 14 may include a platform 19 for supporting a tank 16, pump equipment (not shown) and other components. The platform 19 may be integrated with the fertilizer bar 14, the hitch bar 18 or both. The fertilizer bar 14 may include planting equipment, in addition to the fertilizing equipment. For example, the fertilizer bar 14 may include a fluid bar having apertures for the fertilizer to be distributed, as well as a device for creating furrows (e.g., a disc opener) and a seed distributor for placing the seeds within the furrow. However, the fertilizer bar 14 may be separate from the planting equipment or integrated within a single bar. The fertilizer bar 14 may additionally be part of the tractor 10. For example, the bar 14 may be an integrated accessory for the tractor 10.

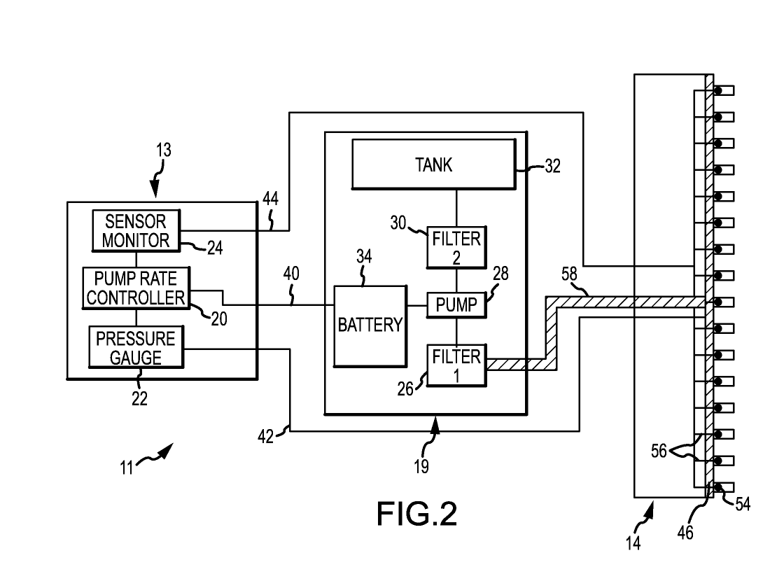

The fertilizer system for monitoring the amount of fertilizer distributed into each furrow may be implemented in combination with the fertilizer bar 14 and the tractor 10. FIG. 2 illustrates a block diagram view of some embodiments of the fertilizer system 11. The fertilizer system 11 may include monitoring and adjusting equipment 13. This monitoring and adjusting equipment 13 may be located within the cab 12 of the tractor 10. This arrangement allows the farmer to monitor and adjust the fertilizer system 11 while operating the tractor 10. The monitoring and adjusting equipment 13 may be electrically connected to components hosted on the platform 19 as well as components hosted on the fertilizer bar 14. The platform 19 may further include a fluid connection between the components hosted on the platform 19 and the fertilizer bar 14.

The platform 19 may support the tank 16, a first filter 26, a pump 28, a second filter 30, and a battery 34. The tank 16 may be fluidly connected through a hose or other suitable fluid connection member or system to the first and second filters 26, 30 and the pump 28. The tank 16 may hold liquid fertilizer, water, or any other desired materials for depositing within a furrow. The first and second filters 26, 30 may filter the fertilizer or other materials deposited into the furrow. The first filter 26 may receive liquid from the pump 28 and then deliver the fertilizer to the fertilizer bar 14 via a fluid conduit 58. The fluid conduit 58 may be any type of connection able to transmit fluid, such as a hose, a pipe, or the like. The second filter 30 may receive the fertilizer from the tank 32 and distribute it to the pump 28. The filters 26, 30 may be any type of filter, for example, a simple screen to remove large particles from the fertilizer or a more complex chemical filter for removing unwanted chemical compounds. One or more filters may be used to help keep the orifices from becoming plugged. Although two filters are illustrated in FIG. 2, there many be any number of filters included within the fertilizer system 11. Additionally, if no filtering is desired, the filters 26, 30 may be omitted.

The pump 28 may be located between the first filter 26 and the second filter 30. The pump 28 pulls fertilizer from the tank 32 and delivers the pulled fertilizer to the fertilizer bar 14. In some embodiments, the pump 28 may pump between a range of 0-40 gallons per minute. However, the pump 28 may be designed to pump at any desired level, for example, faster or slower than 30 gallons per minute. The pump 28 may be an electric pump and may include a diaphragm to control the fertilizer flow through the pump 28. The pump 28 may also include rollers that press the diaphragm in order to move the fertilizer through the pump 28. The pump 28 may be any other type of pump, including, but not limited to, a centrifugal pump, plunger pump, and so on. In addition to being connected to the filters 26, 30, the pump 28 may also be connected to the battery 34. In some embodiments, the battery 34 supplies power to the pump 28. For example, if the pump 28 is an electric pump, the battery 34 supplies the electricity required to operate the rollers or other electrical components. The battery 34 may be any type of battery, such as a 12 Volt alkaline battery, a rechargeable battery, and so on. The battery 34 may also be omitted. For example, the pump 28 may be wired to receive power from the tractor 10 engine or another power source. The battery 34 and the pump 28 may additionally be connected to the monitoring and adjusting equipment 13. In this implementation, the battery power level as well as the pump rate may be monitored by the farmer from within the cab 12.

The monitoring and adjusting equipment 13 may include a sensor monitor 24, a pump rate controller 20, and a pressure gauge 22. The pump rate controller 20 is electrically connected to the battery 34 and the pump 28. The pump rate controller 20 may be connected to the battery 34 via a controller wire 40. The pump rate controller 20 may be utilized to adjust the pump rate of the pump 28. The pump rate controller 20 may include a display or other user interface to allow an operator of the tractor 10 to adjust the pump 28 from the cab 12. The display or interface (not shown) may include an analog or digital display to illustrate the current rate of the pump flow and a knob, one or more button, a touch screen or other control mechanism to allow the operator to change the pump flow rate. In some embodiments, the adjustment control mechanism may provide the operator a predetermined number of options for the pump flow rate, such as low, medium and high speed. The display or interface feature allows the operator of the tractor to adjust the amount of fertilizer deposited in the furrows from the convenience of the cab 12. This also allows the operator to adjust the fertilizer output while the system is operating without having to stop the tractor 10. The pump controller 20 may be any device that can control the pump rate of a pump. For example, if the pump 28 is an electrical pump, the pump controller 20 may be an electrical dial connected to the rollers and/or diaphragm to alter the speed of the rollers in response to the operator's selected input.

The pressure gauge 22 may be electrically connected to the pump rate controller 20. The pressure gauge 22 measures the pressure of fertilizer distributed by the fertilizer bar 14. Similar to the pump rate controller 20, the pressure gauge 22 may include a user display and/or interface. The user display and/or interface (not shown) illustrates to the tractor operator the current pressure and may be shown using a numerical output, a needle indicator, etc. This feature provides the tractor operator with a current reading of output pressure in order to better determine the amount of adjustment (if any) necessary for the pump 28. Also, the pressure gauge 22 may alert the farmer if the pump 22 or other components are malfunctioning. For example, if the pressure gauge 22 displays a low pressure the tractor operator may then inspect the pump 28 for a potential problem.

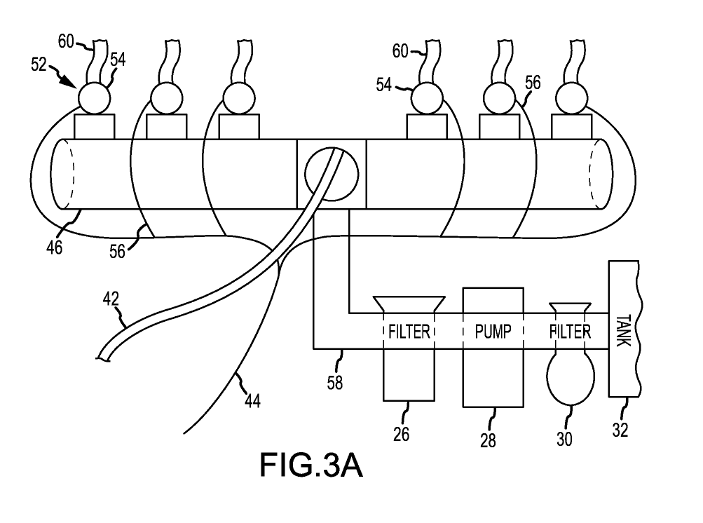

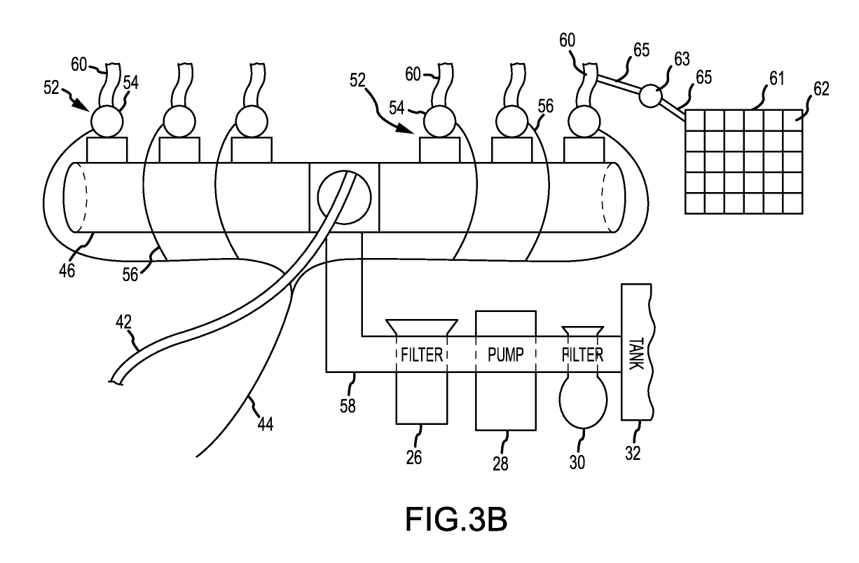

Referring now to FIGS. 2 and 3, the sensor monitor 24 may be electrically connected to a fluid bar 46 attached to the fertilizer bar 14. Specifically, the sensor monitor 24 may be electrically connected to sensors 54, meters, or the like located at mount apertures along the fluid bar 46. The sensors 54 measure the rate of fertilizer flowing (including the absence of flow) through each aperture, and the sensor monitor 24 displays the results. The sensors 54 may be any suitable sensor for measuring the flow rate of a fluid, such as a flow nozzle, velocity flow meter, venturi tube, etc. In some embodiments, the sensors 54 may also measure the pressure of the fluid. For example, the sensors 54 may be placed within the mount aperture and as such determine the pressure exiting the outlet of the mount aperture as well as the pressure of the fertilizer as it enters the hose 60 attached to the end of the mount 52. In some embodiments, the sensors 54 may detect the type of fertilizer being applied by detecting an identifying characteristic of the fertilizer. For instance, the sensors 54 may be configured to detect a physical or chemical property of the fertilizer to determine or recognize the identity of the fertilizer being applied. In one implementation, the sensors 54 may be configured to detect an elemental composition of the fertilizer, such as a percentage of nitrogen, phosphorus, potassium, calcium, magnesium, sulfur, boron, chlorine, copper, iron, manganese, molybdenum, and/or zinc. The detected percentage(s) may be compared against a calibration table, for example, to determine the identity of the fertilizer.

Additionally or alternatively, a unique identifier, such as a metal or a dye, may be added to each different type of fertilizer, and the sensors 54 may be configured to detect the identifiers. The sensors 54 may include optical sensors, chemical sensors, electric current or resistance sensors, thermal sensors, or any other suitable sensors. The sensors may be used as part of a photometric, electrometric, chromatograph, mass spectrometry, thermal conductivity, physical property (such as density and specific gravity), and/or any other suitable analysis to determine the composition of the applied fertilizer. For example, optical sensors may be used to detect the intensity of light or other electromagnetic waves and may be a part of a photometer, refractometer, turbidimeter, and/or opacity meter. As another example, electric current or resistance sensors may be used to detect the fertilizer's ability to conduct an electric current. After detection, the fertilizer information may be stored for later analysis and/or reporting.

Additionally or alternatively, the fertilizer system may be configured to store samples of the fertilizer for later analysis. Referring specifically to FIG. 3B, the fertilizer exiting the outlet of each of the mount apertures 52 of the fluid bar 46 may be in fluidic communication with a fluid reservoir 61 having a plurality of storage cells 62. As fertilizer is applied to the field, a valve 63 may be automatically controlled to open at set time intervals (for example every minute) for a set time period (for example a second) to permit fluid flow through a tube 65 into the fluid reservoir 61, thereby capturing a sample of the fertilizer being applied to the field. The fertilizer system 11 may be configured to record, for example, the flow rate, pressure, temperature, time, and location of each sample.

A movable dispenser, a manifold with a plurality of selectively openable exit ports each positioned above a respective storage cell 62, or other suitable devices may be associated with the fluid reservoir 61 to direct the fertilizer samples into individual storage cells 62. A sensor 54 may be operably associated with each storage cell 62 to analyze the fertilizer sample real-time or substantially real-time. Additionally or alternatively, after completion of a fertilizer application, the fluid reservoir 61 may be removed from the fertilizer equipment, such as the fertilizer bar 14, and transported to a remote site (such as a lab or testing facility) for analysis of the fertilizer. The valve 63 may be electrically, hydraulically, and/or pneumatically actuated. Although only one mount aperture 52 is in fluidic communication with one fluid reservoir 61 in FIG. 3B for simplicity purposes, each mount aperture 52 of the fluid bar 46 may be in fluidic communication with the fluid reservoir 61 or with individual fluid reservoirs. As such, the fertilizer system may store fertilizer samples associated with each row in a field for later analysis. The data may be used to correlate the application time, date, and amount of fertilizer with crop growth or yield parameters (e.g., emergence data or ultimate yield) and field parameters (e.g., geographical location, elevation, slope, and soil type).

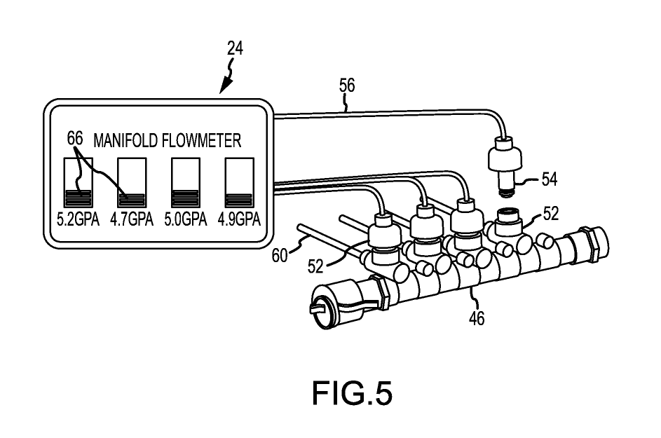

FIG. 5 illustrates another embodiment of the fluid bar 46 and sensor monitor 24. Referring now to FIGS. 2, 3, and 5, the sensor monitor 24 may include a user display 66 located in the cab 12 of the tractor 10. The display 66 indicates to the tractor operator the amount of fertilizer being discharged by the system 11. In these embodiments, the sensor monitor 24 may be directly connected to each mount 52 and each sensor 54. This allows the sensor monitor 24 to include a display 66 for each mount aperture and each mount 52. The display 66 may include a reading of the flow rate registered by each sensor 54. For example, the display 66 may have a digital number output, a dial, a graphical display, etc. The reading may display gallons per minute, gallons per acre, liters per minute, etc.

These embodiments allow for the tractor operator to determine the type of adjustments that may be necessary to the pump 28. For example, if too much fertilizer is being discharged from the system 11, the tractor operator may be worried about harming the seeds and may subsequently adjust the pump 28 via the pump controller 20 to lower the flow rate. Additionally, the sensors 54 may indicate to the tractor operator whether the system is operating properly. For example, if one of the mount apertures is blocked or clogged, the sensor 54 will measure a low or zero flow rate. This would alert the tractor operator that there may be a problem with the aperture associated with the sensor 54.

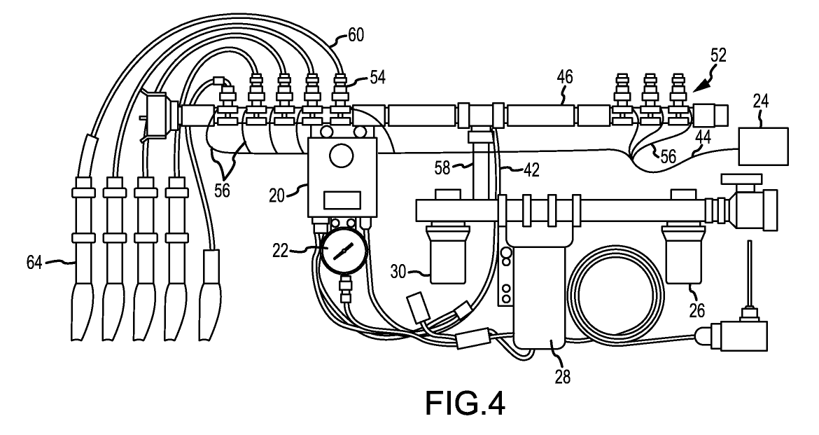

The sensor monitor 24 may be connected to the various sensors 54 through a sensor wire 44, such as shown in FIG. 4, or may be wirelessly connected with the various sensors 54. The sensor wire 44 may extend between the sensor monitor 24 and the sensors 54. The sensor wire 44 may be mounted on the hitch bar 18 and the platform 19. The sensor wire 44 may additionally be formed of individual wires 56 that converge to form a single wire line that is connected to the sensor monitor 24. These individual wires 56 each receive an electronic signal from the sensors 54 and then send such signal back through the sensor wire 44 to the sensor monitor 24. The sensor wire 44 may be a singular electrical bus providing a signal path for each of the individual wires 56, or the sensor wire 44 may be simply the extension and combination of all the individual wires 56. In other embodiments, the sensor wire 44 may be omitted, such that each individual wire 56 directly connects to the sensor monitor 24, as shown in FIG. 5. The connectivity of the system, between components, may be wireless.

Referring again to FIGS. 2 and 3, the pressure gauge 22, in addition to being electrically connected to the pump controller, may also be disposed within the fluid bar 46. The pressure gauge 22 measures the pressure of the fertilizer flowing from the first filter 26 to the fluid bar 46. The pressure gauge 22 may be connected to the fluid bar 46 via a gauge wire 42. The gauge wire 42 may be mounted along the hitch bar 18 and/or the platform 19 on its way from the pressure gauge 22 to the fluid bar 46. The pressure gauge 22 may be located at the outlet of the first filter 26, at the inlet of the fluid bar 46, or may be located at the outlet of the pump 28. The variety of locations allows for the pressure gauge 22 to be positioned to determine the pressure at any desired location within the fluid flow. Additionally, although a singular pressure gauge 22 has been shown, multiple gauges may be used. For example, the tractor operator may wish to know the pressure of the fertilizer leaving the pump 28, and also the fluid pressure as it enters the fluid bar 46. In these cases, two or more pressure gauges 22 may be implemented within the fluid flow to give an accurate reading of fluid pressure at different locations. The pressure gauge 22 may include a sensor (not shown) for measuring the pressure in the fluid bar 46. The sensor may be any device capable of determining pressure changes, for example a spring, hydraulic fluid, etc. The purpose of the pressure gauge is to help regulate the flow rate, such as in gallons per acre. By monitoring the pressure gauge, such regulation may be accomplished. The pressure gage may work in concert with the sensor to help regulate the flow of liquid.

FIG. 3 is a enlarged view of one embodiment of the fluid bar 46. The fertilizer bar 14 may include the fluid bar 46. The fluid bar 46 may be cylindrically shaped and hollow or any other desired shape. The fluid bar 46 defines a passageway for fertilizer to flow when transported via the fluid conduit 58 from the first filter 26. The fluid bar 46 in some embodiments is polyvinyl chloride (PVC), however the fluid bar 46 may be any suitable material, such as metal, other types of plastic, etc. Additionally, the fluid bar 46 in some embodiments may take the form of ¾ inch PVC, however in other embodiments the fluid bar 46 may be other sizes or materials, depending on the fertilizer requirements. For example, if the fields to be fertilized require a large amount of fertilizer, the fluid bar 46 may have a larger diameter to accommodate more fluid. The fluid bar 46 may be attached to the fertilizer bar 14, may be attached to a planting tool bar (not shown) or may be a separate device. This attachment feature makes the fluid bar 46 versatile because it may be added to an existing planting or fertilizing bar or may operate on its own. In some embodiments, the fluid bar 46 may be attached to a fertilizer bar 14 provided as part of the tractor 10 assembly. This allows the fertilizer system 11 to be added to tractor operator's existing equipment, which may result in a reduction of expenses.

The fluid bar 46 may include mounts 52, which have apertures (not shown), and may be attached to hoses 60 or other fluid transporting apparatuses. Each mount 52 may be configured to attach and secure a respective hose 60 to the fluid bar 46. Additionally the mounts 52 may be configured to provide for a variety of different attachments. For example, the mounts 52 may be used in conjunction with spray nozzles to spray the fertilizer into the furrow. Similarly, the mounts 52 may be used with a sprayer to spray water above the ground, without depositing the water directly into a furrow. However, depending on the type of hose 60, or other attachment used with the fluid bar 46, the mounts 52 may be omitted. For example, the hose 60 may include another attachment mechanism that allows for attachment directly to the fluid bar 46. In some embodiments, the hose 60 may be ¼ inch tubing, however in other embodiments the hose 60 may be other sizes. The mount apertures may be located at any position on the mounts 52 and additionally may be any diameter. The size and position of the apertures depends on the tractor operator's needs. For example, to increase the amount of fertilizer deposited to the hoses 60, the mount apertures may be larger. On the other hand, if the tractor operator wants to deposit less fertilizer in each furrow, the mount apertures may be smaller.

The pressure gauge wire 42 may be located within the fluid bar 46, such that the pressure gauge wire 42 may measure the pressure of the fertilizer flowing through the passageway. As discussed above, the pressure gauge 22 may include a sensor or other device for measuring the pressure within the fluid bar 46. As such, the pressure gauge wire 42 may include the sensor and may transport the readings from the fluid bar 46 to the gauge, or the pressure gauge 22 may be located on the end of the pressure gauge wire 42 inserted within the fluid bar 46. In some embodiments, the pressure gauge wire 42 is ¼ inch tubing. However, the pressure gauge wire 42 may be any diameter and be constructed out of any appropriate material for transporting pressure data.

In operation, the fertilizer may travel from the tank 32 through the second filter 30, through the pump 28, through the first filter 26, and through the fluid conduit 58 before reaching the passageway. Once reaching the fluid bar 46 passageway, the fertilizer may exit the fluid bar 46 via the mount apertures. As the mount apertures may be connected to hoses 60, the fertilizer may then enter each hose 60 to be directed to the appropriate location. For example, each hose 60 may be directed to a specific furrow and the fertilizer will be deposited within each furrow.

FIG. 4 illustrates an embodiment of the fluid bar 46 including seed cover assemblies attached to the hoses. Referring now to FIGS. 3 and 4, the hose 60 may be included as part of a seed cover assembly 64. The seed cover assemblies 64 may be used in conjunction with a planting device. In these embodiments, the seed cover assembly 64 directs seeds from the planting device into a furrow. Additionally, the seed cover assembly 64 may also include the hose 60 and may be used to position each hose 60 into a furrow. In this embodiment, the seed and the fertilizer may be deposited at essentially the same time and in the same location within the furrow. This helps to insure that the seed will be able be contacted by the fertilizer, as the fertilizer will be located at the same depth and location as the seed. For example, the hose 60 may be supported by a frame directing the hose into a specific furrow and at a specific angle. Additionally, the hose 60 may include a variety of different nozzles, or end pieces to direct the fertilizer appropriately into the ground. Of course, no seed cover assemblies need be used with this system.

In one embodiment, the system monitors whether or not there is flow, and if there is flow sensed, it may also monitor and or measure what the flow rate is. The system may store in memory, for potential later recall and use, the volume (such as gallons) applied per acre. This data may be used to determine the average volume applied per acre, or may be used to determine where (location) liquid was applied in the acre, when such application data is cross referenced with a GPS (global positioning system) data acquisition that maps the movement of the application system in a given area (such as a farm field).

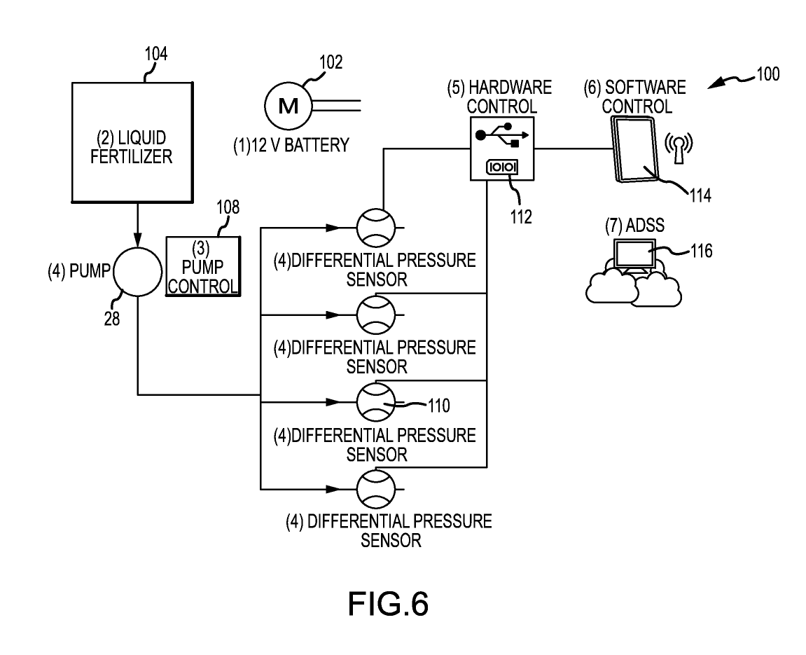

FIG. 6 illustrates a schematic view of a system for monitoring the application of liquid fertilizer onto an agricultural field. The system may be configured to provide automated monitoring of a liquid fertilizer application via electrical sensors. The system may further be configured to monitor one or more of the following situations: the plugging of a liquid fertilizer tube or row unit; when and where the liquid fertilizer tube or row unit was plugged; a demand flow ratio or a flow rate of the liquid fertilizer; and a temperature of the liquid fertilizer. By monitoring such parameters, the system provides a mechanism to help ensure that liquid fertilizer is properly applied during the planting of crops to increase the likelihood that good stands and crop yields are obtained. Further, in some embodiments, the system may be further configured to capture this information on a hosted solution that allows for the overlay of this data with other information, such as, but not limited to, pH of the soil, rain or other weather events, and market conditions.

With reference to FIG. 6, the system 100 may include a power source 102, a liquid fertilizer or other liquid source 104, a pump 28, a pump control 108, one or more pressure sensors 110, a hardware control 112, a software control unit 114, and a hosted software solution 116. The power source 102 may be utilized to provide power to one or more of the pump 28, the pump control 108, the hardware control 112, and the software control unit 114. The power source 102 may be a 12 volt battery or any other suitable electrical power supply. As described in more detail above, the pump 28 may be fluidly connected to the liquid source 104 and configured to deliver fluid from the liquid source 104 to the hoses 60 that are in fluid communication with the pump 28. The pump 28 may be controlled using the pump control 108. The pump control 108 provides the ability for an operator to operate the pump 28 to deliver a desired amount of liquid from the liquid source 104 to the hoses 60.

The pressure sensors 110 may be positioned between the pump 28 and the hoses 60. In some embodiments, each pressure sensor 110 may be installed on each row of the fertilizer manifold or fluid bar 46. In such embodiments, each pressure sensor 110 may be configured to measure the differential pressure based on the readings of two absolute sensors. This information may then be utilized to determine the liquid flow rate through a respective hose 60. The pressure sensors 110 may be configured to sample the flow rate up to 50 times per second, or at any other desired sampling rate. This information may be retrieved using a serial port or the like that is connected to the pressure sensors 110. The serial port may be part of the hardware control 112 and may be a RS485 serial port or any other suitable serial port.

The hardware control 112 may be connected to the pressure sensors 110 and to the software control unit 114. The hardware control 112 may take the form of a hardware BUS that interfaces between the pressure sensors 110 and a USB standard output. The hardware control may be powered to strengthen the USB signal to allow the signal to be transferred greater distances.

The software control unit 114 may include one or more of the following modules: management software, an interface layer, processing logic, and a user interface. The management software may contain the management functions that are needed to query the sensors on the BUS and to configure/store the unique BUS address for each sensor. The management software may then be used to query to BUS via an appropriate protocol, such as a RS485 protocol, to retrieve the pressure information. The interface layer may contain the required interface logic to translate between the commands for a mobile operating system and the pressure device internal RS485 protocol. The processing logic module may contain the logic needed to poll the sensor device through the interface on a configurable interval and to store the pressure/flow rate information into an internal database. The processing logic module may further be configured to receive and record other pertinent information, such as the longitude and latitude of a tractor or other farm equipment that is obtained using GPS equipment, identification information for operators of the software or the farm equipment, temperature of the liquid, timestamp information, speed of the implement, identification of the liquid being applied (such as water, fertilizer, insecticide, fungicide, and other suitable liquids), and other configuration data. The user interface may be configured to display pressure readings obtained from the pressure sensors. In some embodiments, each sensors' measurements may be displayed and alarms may be triggered in the event that the readings from one or more of the sensors falls outside of configurable maximum and minimum readings.

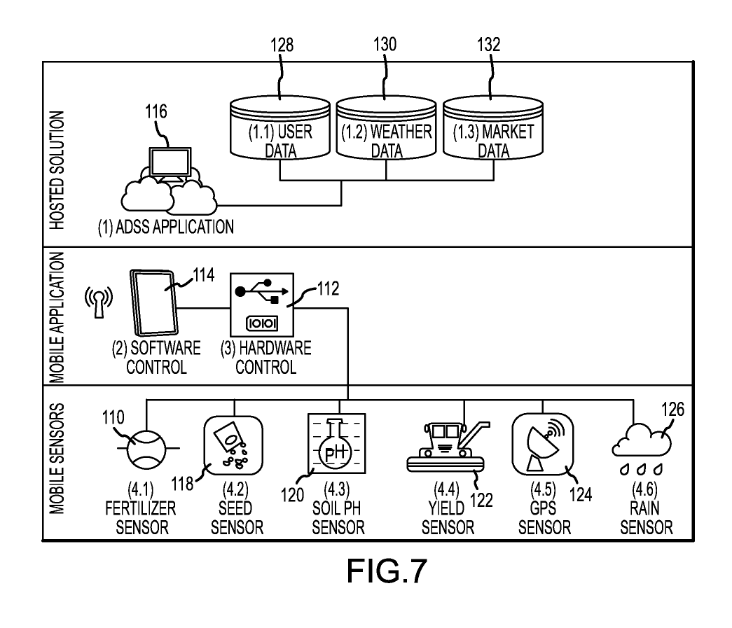

FIG. 7 shows a schematic illustration of an example architecture and design for providing information to the hosted software solution 116. With reference to FIG. 7, various sensors may be joined to the software control unit via the hardware control. The sensors may include fertilizer flow rate or pressure sensors or meters 110, seed sensors 118, soil pH sensors 120, yield sensors 122, GPS sensors 124, rain sensors 126, and any other sensors that measure desired information. As described in more detail above with respect to the pressure sensors 110, each of these sensors may be joined to the hardware control 112, which may be configured to receive signals or the like from the sensors and transfer these signals to the software control unit 114 for analysis and storage. The software control unit 114, in turn, may be configured to deliver the information received from the sensors via the hardware control 112 to the hosted software solution 116. The information may be delivered wirelessly or may be delivered by connecting the software control unit 114 to hardware containing the hosted software solution 116 via a wire or the like. The hosted software solution 116 may further be configured to receive user data 128, weather data 130, market data 132, and other information of interest from various databases. This data may reside in databases stored on the hardware for the hosted software solution 116 or may be stored on remote databases in which the information is transmitted to the hosted software solution 116 via an appropriate wired or wireless connection.

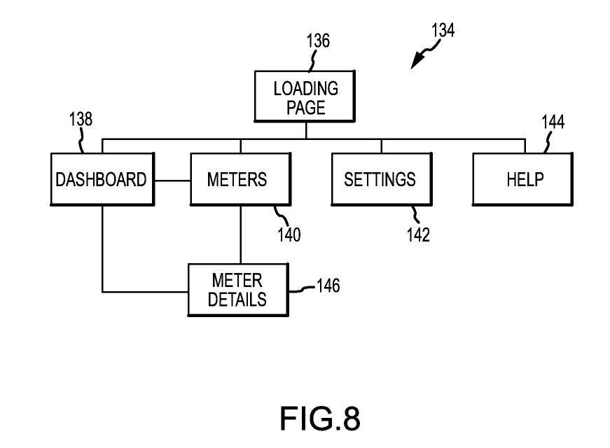

FIG. 8 illustrates an example navigation map 134 for the user interface of the software control unit 114. The navigation map 134 may include a loading screen 136, a dashboard screen 138, a meters screen 140, a settings screen 142, a help screen 144, and a meter details screen 146. Further, the user has access to a “back” button that returns the user to any previously viewed screen except the loading screen 136. The user may also be provided with a menu that allows the user to navigate to any of the dashboard screen 138, the meters screen 140, the settings screen 142, and the help screen 144 from other screens. Additionally, from the dashboard screen 138, the user may navigate to the meters screen 140 or the meters detail screen 146 by selection of events displayed on the dashboard screen 138. Yet further, from the meters screen 140, the user may navigate to a meter details screen 146 that presents detailed information about the particular meter selected.

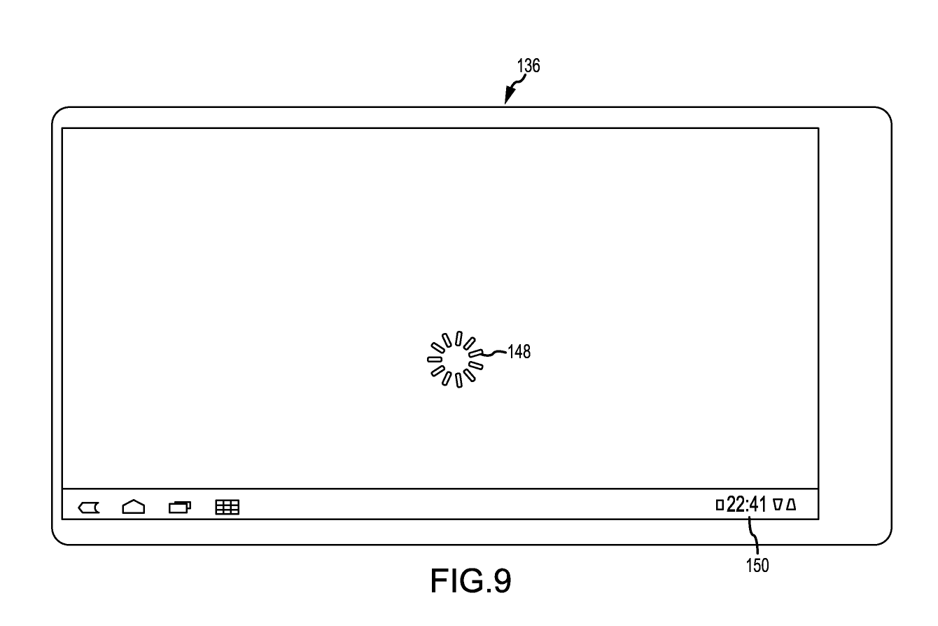

FIG. 9 illustrates a potential loading screen 136. The loading screen 136 may be presented to the user when the user launches the software application. The loading screen 136 may be visually presented to the user until the application has preloaded any configuration information and preset application settings. The loading screen 136 may include a loading icon 148. The loading screen 136 may further include a name of the application or other visual feature that identifies the application. If desired, a clock 150 may also be displayed on the loading screen 136.

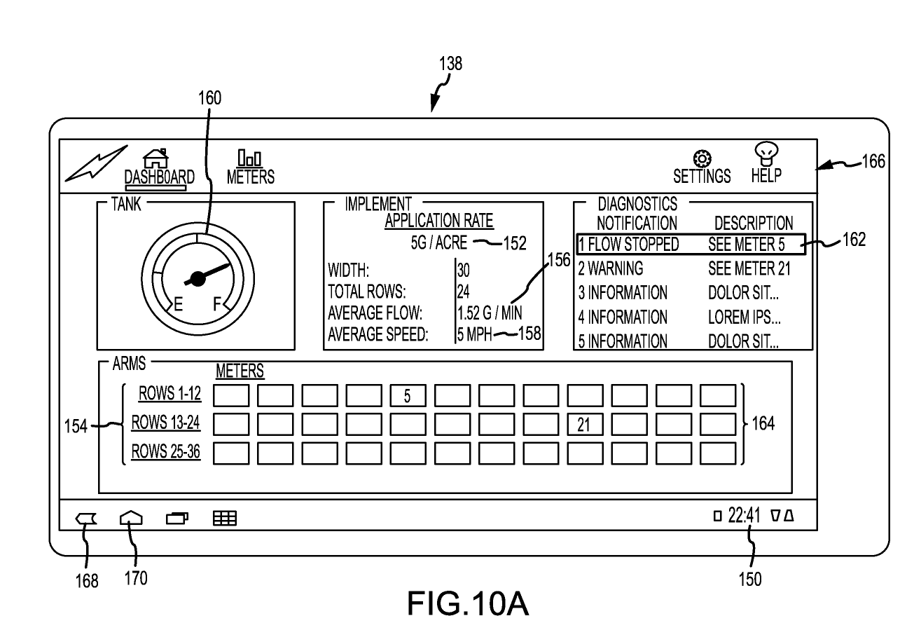

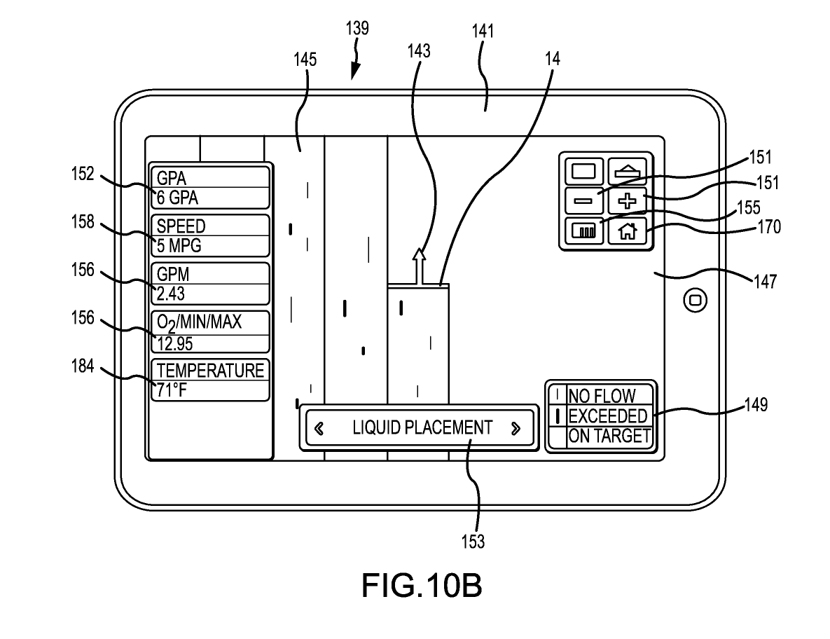

FIG. 10A illustrates a potential dashboard screen 138. After the application loads, the loading screen 136 may be replaced by the dashboard screen 138. A purpose of the dashboard screen 138 is to present the user with a visual summary of activity related to monitoring of the pressure or flow sensors or meters. Accordingly, the dashboard screen 138 may display information about current implementation information, such as the current desired fertilizer or other liquid application rate 152, the number of rows 154 being fertilized or treated, the average flow rate 156 of the fertilizer or other liquid, and the average speed 158 of the tractor or other farm equipment. The dashboard screen 138 may also display a fuel tank gauge 160 that shows an estimate of the amount of liquid remaining in the liquid supply source. The dashboard screen 138 may further display a predetermined number of alerts or other notices 162 raised by the application.

The dashboard screen 138 may also display a global “heat map” 164 of the sensor or meters and the status of the sensors or meters. The heat map 164 may be designed to provide visual information to the user so that a glance the user can assess whether there are any issues that need to be resolved. For example, each sensor or meter may be represented by a square or other symbol that is colored a particular color (e.g., green, yellow, or red) to inform a user whether or not the sensor or meter is operating within specified particulars. For example, when the square representing a sensor or meter is green, this color may inform the user that a sensor or meter is measure a flow rate or other measured information that is within predetermined parameters. Similarly, if the square representing a sensor or meter is red, this color may inform the user that the sensor or meter is indicating the flow rate or other measured information is not within the predetermined parameters, and thus may required attention. The display may also be configured to display the number of the sensor or meter within the square to indicate which sensor or meter is showing an issue. For example, assume there is an issue with the flow rate through sensor or meter 5 and a potential issue with the flow rate through sensor or meter 21. In this scenario, the numbers “5” and “21” may be displayed in their respective squares or other objects so the user may readily identify which sensor or meter is indicating that there is an issue with the flow through the sensor or meter.

A menu 166 may be positioned at the top of the dashboard screen 138 or at any desired location on the dashboard screen 138. The menu 166 may allow the user to directly navigate to the meters, the settings, or the help screens 140, 142, 144. Further, the user may navigate to the meters screen 140 by selecting one of the row labels. Yet further, the user may navigate to the meter details screen 146 for a particular sensor or meter by selecting the square or other object that represents the sensor or meter.

At the bottom of the dashboard screen 138 or at any suitable location, a back button icon 168, a clock 150, and any other desired information or icons may displayed. The back button icon 168 allows a user to return to any immediately previously displayed screen except the loading screen 136. The clock 150 may provide a visual representation of the current time. Other icons may include a home icon 170 that allows the user to return to a predetermined home screen.

FIG. 10B illustrates a potential dashboard screen 139. A purpose of the dashboard screen 139 is to present the user with a visual summary of liquid placement in a field. Accordingly, the dashboard screen 139 may provide a liquid placement map 141 depicting a location of a fertilizer bar 14, a direction of travel 143 of the fertilizer bar 14, a treated area 145 (for example, fertilized), and an untreated area 147. The treated area 145 may be colored or shaded to indicate areas of acceptable and unacceptable flow, pressure, and/or temperature based on preset thresholds, and a legend 149 may be provided to facilitate comprehension of the liquid placement map 141. The dashboard screen 139 may further include zoom buttons 151 and a scroll bar 153. The dashboard screen 139 also may provide a liquid application rate 152, an average flow rate 156 of the fertilizer or other liquid, an average speed 158 of the tractor or other farm equipment, and a temperature 184 of the fertilizer or other liquid.

Similar to the dashboard screen 138, the screen 139 may include icons to allow a user to navigate to other screens. For example, the dashboard screen 170 may include a home icon 170 that allows the user to return to a predetermined home screen and a meter details icon 155 that allows the user to view a meter details screen 146. A user also may navigate to the meter details screen 146 for a particular meter by selecting a position on the map 141 associated with a desired meter.

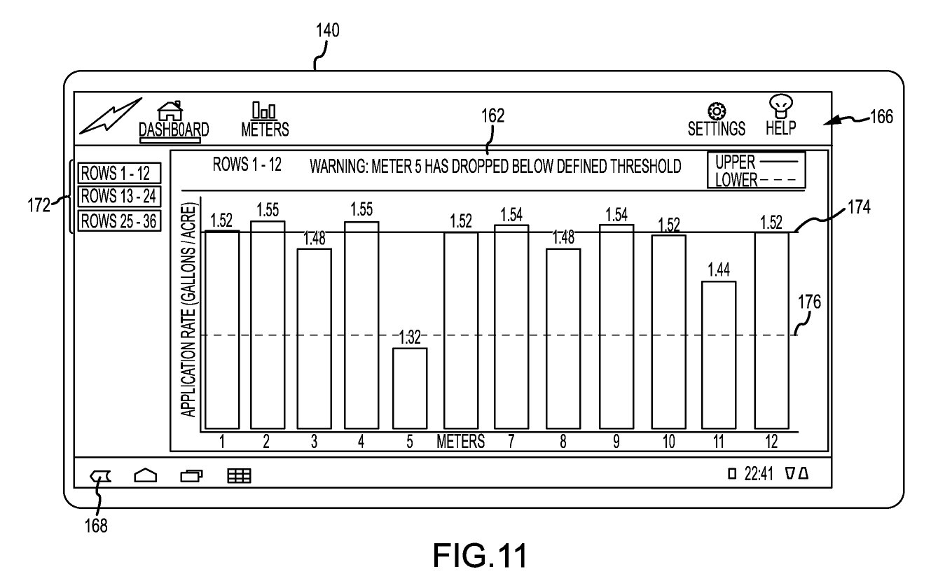

FIG. 11 illustrates a potential meters screen 140. The meters screen 140 may display the flow rates for a predetermined number of sensors or meters. With reference to FIG. 11, the current flow rates measured by sensors or meters 1-12 are shown. To select another group of sensors or meters to display, tabs 172 may be provided to indicate the various groups of sensors or meters that are available to be displayed. Selecting one of these tabs 172 results in that group of sensors or meters being displayed. In addition to showing the current flow rates measured by the selected group of sensors or meters, lines that represent upper and lower flow rate thresholds 174, 176 may be displayed to provide a visual indication of whether a particular flow rate as measured by the sensor or meter is within the upper and lower flow rate thresholds 174, 176. An alert or warning 162 for any of the sensors or meters may also be displayed on the meters screen 140.

Similar to the dashboard screen 138, the menu 166 may be displayed at the top of the meters screen 140, or at any desired location, to allow a user to navigate to the other primary screens. Also, the back button icon 168 and other icons or information may be displayed at the bottom of the meters screen 146, or at any other desired location. Finally, a user may navigate to the meter details screen 146 for a particular meter by selecting the graphical bar associated with the desired meter.

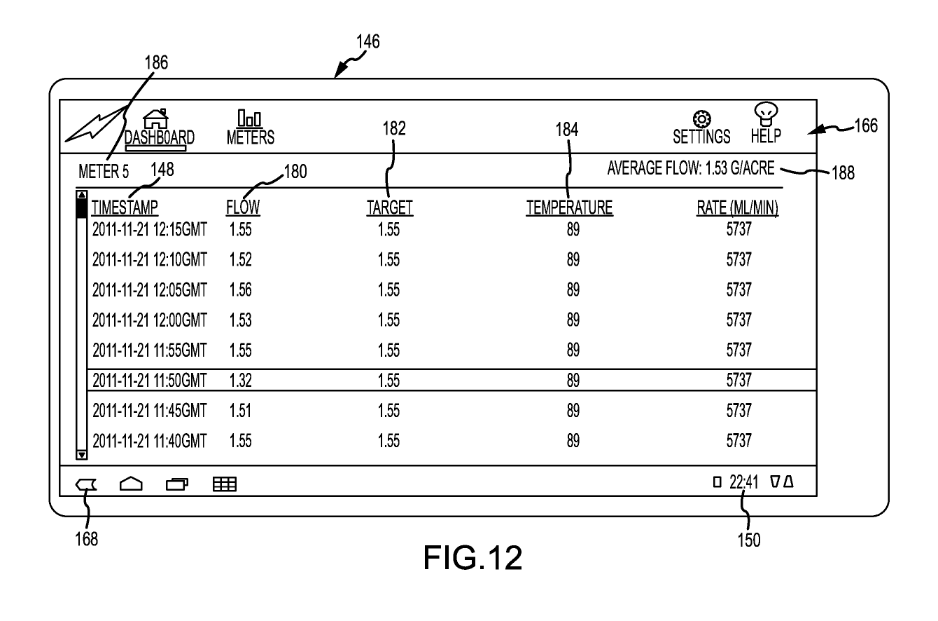

FIG. 12 illustrates a potential meter details screen 146. The meter details screen 146 may provide the user with detailed information about a particular sensor or meter. The provided information may include time that a measurement occurred 178, flow rate 180, target flow rate 182, temperature 184, and any other desired information. The information may be organized to display the flow rate 180, the target flow rate 182, and the temperature 184 at a specific time. The meter details screen 146 may also be configured to display an identification 186 of the sensor or meter being displayed and the average flow rate 188 as measured by the sensor or meter over a specified time period. Also, like the dashboard screen 138 and the meters screen 140, the meter details screen 146 may include the menu 166, the back icon button 168, the clock 150, and other icons or information.

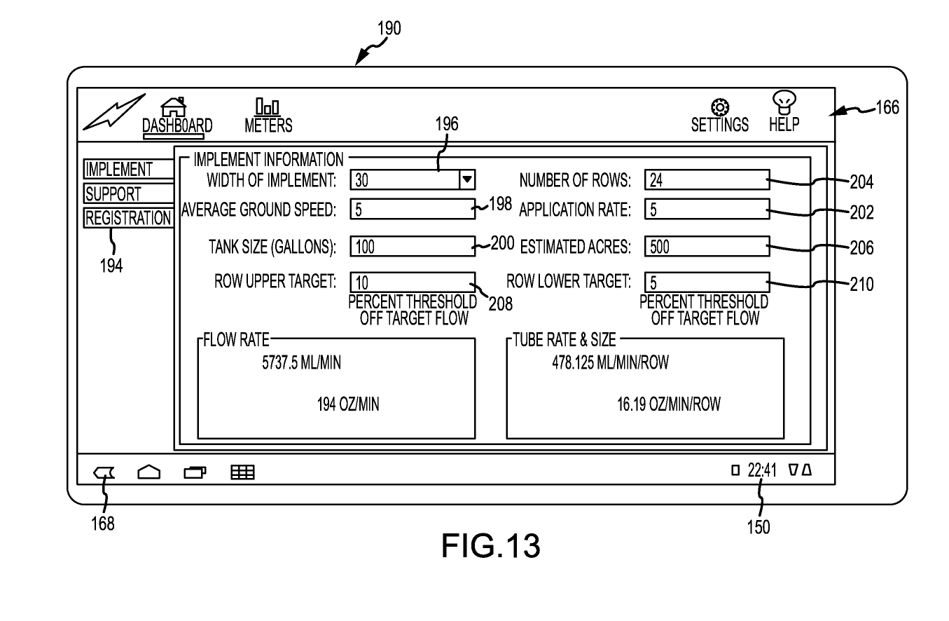

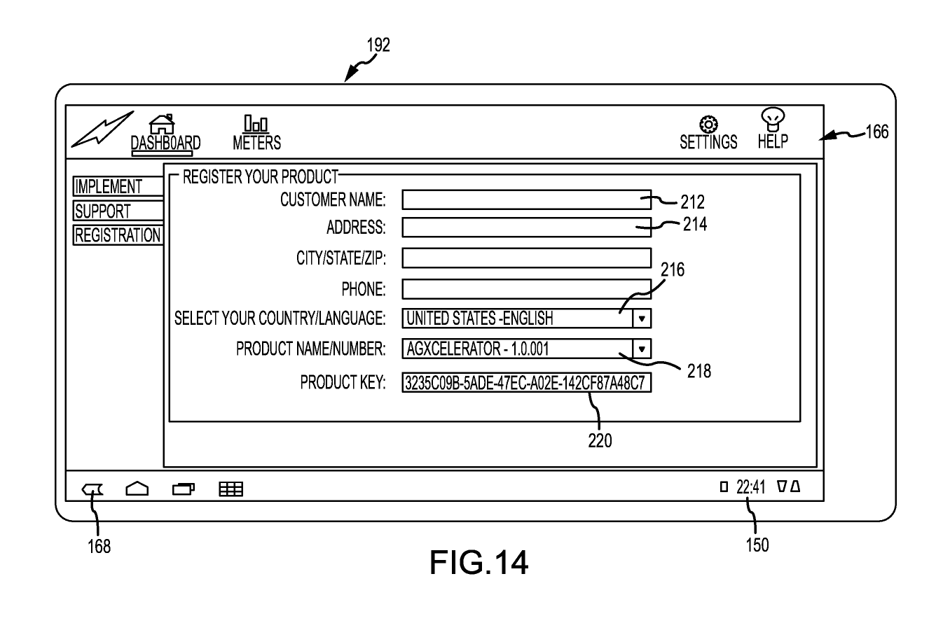

FIGS. 13 and 14 illustrate potential settings screens. In particular, the setting screens may include at least an implementation screen 190 and a registration screen 192. The implementation screen 190 may be initially displayed when the settings screen 142 is selected. The registration screen 192 may be accessed via a tab 194 on the implementation screen 190. With reference to FIG. 13, the implementation screen 190 may provide a display that allows a user to input predetermined information for a fertilizer or other liquid application. The information may include the width 196 of the fertilizer bar, the average speed 198 of that tractor or other farm equipment, the size 200 of the liquid supply source, the desired flow rate 202 of the liquid, the number of rows 204 to which liquid is delivered by the fertilizer bar, the estimated acres 206 to be treated with the liquid, and a percentage difference for the upper and lower threshold targets 208, 210 for the flow rate. With reference to FIG. 14, the registration screen 192 may include fields for the user to input or select user information, such as name 212 and address 214 of the user, the language 216 for displaying information, the product name 218, and the product key 220. Further, like the other screens, the implementation and registration screens 190, 192 may include the menu 166, the back button icon 168, the clock 150, and other icons.

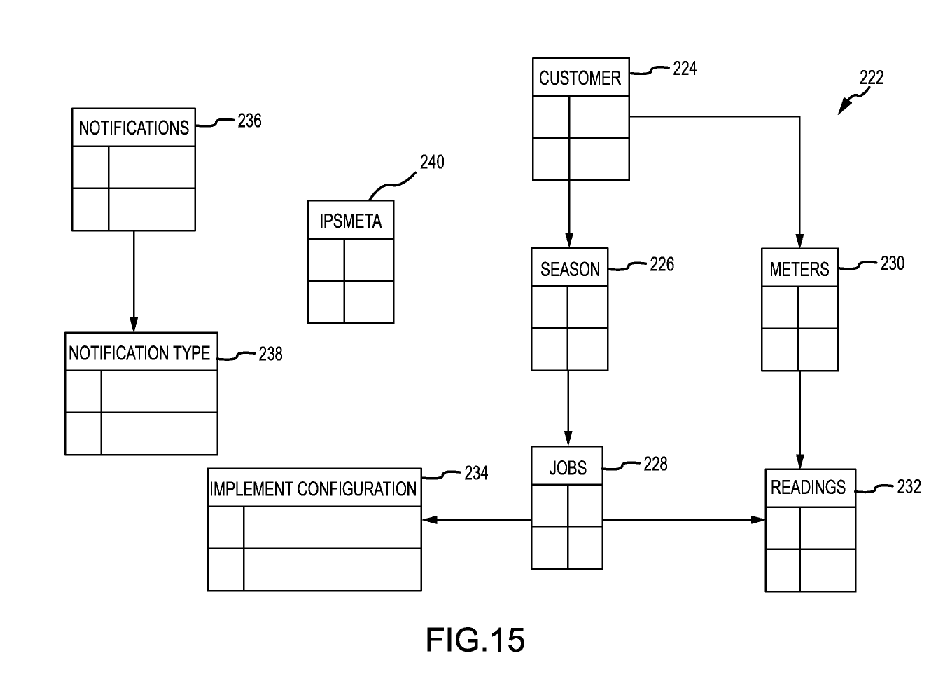

FIG. 15 illustrates a potential database configuration for the software control module 114. The database 222 may be configured to record and track key meter and configuration information. For example, the database 222 may include a customer table 224 that stores customer information, such as personal information about the user or users, the product key, and the name of the software product. The database 222 may also include a season table 226 that allows for various timestamps within a certain date range to be grouped together. Such a grouping may allow for year-to-year comparisons of recorded data. The database 222 may also include a jobs table 228 that may be configured to keep track of specific applications of liquid to a field in order to compare the effectiveness of one treatment application to a different treatment application. For example, if a user elected to change the application rate of fertilizer from 5 gallons/acre to 6 gallons/acre, a new job may be identified in the jobs table 228 to allow the effectiveness of the 5 gallon/acre treatment to the 6 gallon/acre treatment to be compared.

Another database table may be a meters table 230 that may be configured to track information about each sensor or meter. Yet another database table may be a readings table 232 that stores information about sensor or meter activity. The readings table 232 may be cross-referenced to the jobs and meters tables 228, 230. Still yet another database table may be an implementation table 234 that records implementation information entered in the settings screen. The implementation table 234 may be cross-referenced to the jobs table 228. There may also be notifications and notification type tables 236, 238 to record notifications or alerts that occur during monitoring of the system. Finally, there may be a meta table 240 that stores information (e.g., viscosity) that may be used in various calculations that are performed by the system.

While particular tables are shown and described for the database 222, the database 222 may include different or other tables. Yet further, while various tables are shown or described as cross-referenced to specific tables, the tables may be set up differently or may be cross-referenced to additional or different tables. Still yet further, the tables may be combined or split up in order to store different or additional information in a particular table.

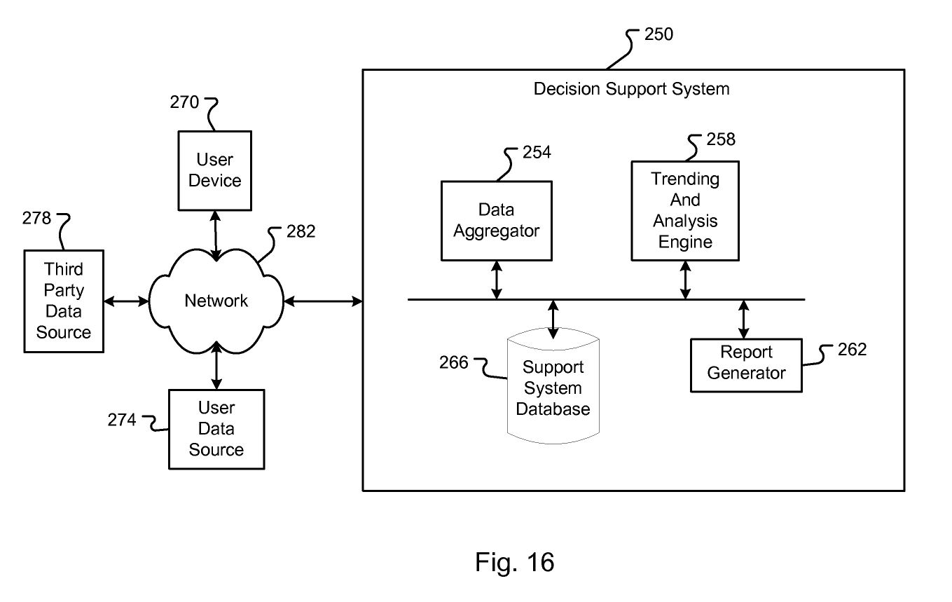

FIG. 16 is a block diagram of an example architecture for a decision support system 250, which may be configured to capture, aggregate, and/or provide users with various types of information to assist users in making farming related decisions. For instance, the decision support system 250 may enable temporal comparisons (for example year-to-year) of liquid application and yields. Additionally or alternatively, the decision support system 250 may provide overlay capabilities with third party data sources to enhance decision making.

The decision support system 250 may be configured to assist users (e.g., farmers) in making planning decisions, real-time decisions, or a combination of both. For example, the decision support system 250 may capture or store (locally, remotely, or both) historic data for analysis of past performance in order to plan for a subsequent planting season. The historic data may include fertilizer information collected during planting, yield data collected during harvest, crop data collected temporally between planting and harvesting, other data or information collected relating to the application of fertilizer to a field, or any combination thereof. The crop data may be collected, for example, using satellite information to determine the appearance of the crops across the field during a growth phase. The user can access the decision support system 250 to review and analyze the historical data to determine factors positively effecting the yield and factors negatively impacting the yield. With this information, the user can alter a current plan or implement a new plan for a subsequent planting season.

Regarding real-time decisions, the decision support system 250 may capture or store (locally, remotely, or both) current or present data, historic data, or both. For example, during planting (real time), the decision support system 250 may be configured to monitor the application of a liquid fertilizer to each row of a field, access historical data (for example yield data cross-referenced with fertilizer information), alert a user of a suggested deviation in the current fertilizer plan based on the historical data, automatically alter current application settings real-time based on the historical data, or any combination thereof to effect an enhanced or improved yield. In this manner, for example, the decision support system 250 may inform a user regarding real-time decisions. The decision support system 250 may be configured to compare the real-time data and the historical data based on similar planting seasons.

The decision support system 250 may include a data aggregator 254, a trending and analysis engine 258, a report generator 262, and a support system database 266. The decision support system 250 may communicate with a third party data source 270, a user data source 274, and a user device 278 via a network 282. The network 282 may be a local area network (LAN), a wide-area network, a virtual network, the Internet, an intranet, an extranet, a wireless network, and/or any other suitable type of network. The network 282 may support data communications using any suitable protocol.

The data aggregator or module 254 may be configured to collect data from various sources, including without limitation the third party data source 270 and the user data source 274. The third party data source 270 may include a fertilizer database(s), location database(s), market database(s), regulatory database(s), seed database(s), soil database(s), weather database(s), yield database(s), and/or any other suitable database(s) that store(s) information accessible by the data aggregator 254. The third party data source 270 may include a database associated with various entities and/or providers. For example, the third party data source 270 may include a regulatory database associated with a government entity, such as a city, county, state, and/or federal government entity. The regulatory database may include regulatory requirements, such as environmental water contamination restrictions, that the data aggregator 254 may access and/or collect for use by the decision support system 250. As another example, the third party data source 270 may include a soil database associated with a third party, such as FarmLogic, Field Logic Inc., and Ag Leader Technology, that contains soil data collected from various locations. The data aggregator 254 may access and/or collect data stored in these soil databases for use by the decision support system 250. As a further example, the third party data source 270 may include a yield database containing yield data collected from yield monitors, such as optical sensors or impact plates, mounted to harvest equipment and collected by third party sources. The data aggregator 254 may access and/or collect yield data stored in third party yield database(s) for use by the decision support system 250.

The user data source 274 may include information collected by sensors 54, 110, pump 28, pump controller 108, software control unit 114, and/or any other monitoring equipment associated with a user or subscriber of the decision support system 250. For example, the data aggregator 254 may collect location data, fertilizer data (including without limitation identification data, flow rate data, pressure data, and/or temperature data), seed data, soil data, weather data, and yield data from the user data source 274. To reduce the transmission sources, the software control unit 114 may serve as the primary source of the user data. The software control unit 114 may include a transceiver for transmitting data to and receiving data from the decision support system 250. The software control unit 114 may be connected to the internet via a wireless connection, a USB hardwire connection, or any other suitable connection to receive the data gathered by the monitoring and adjusting equipment 13 of the fertilizer system 11. The software control unit 114 may store and/or transmit the data through the internet, for example, to the decision support system 250, where the data may be stored for further processing. The data aggregator or module 250 may be hardware, software configured to be executed by a processor, or a combination of both.

Data transfers from the software control unit 114 to the decision support system 250 may be simultaneous, substantially simultaneous, or delayed relative to performance of an event in the field, such as application of a liquid fertilizer. For instance, upon receipt of data from a sensor 54 or 110, the software control unit 114 may simultaneously or substantially simultaneously transmit the data to the decision support system 250. Additionally or alternatively, the software control unit 114 may store the data until a liquid application session is complete and then transmit the data to the decision support system 250.

The trending and analysis engine 258 and the report generator 262 may be configured to process data output requests received from a user device 278, for example. The user device 278 may include various electronic devices including, but not limited to, mobile computing devices (for example, a laptop, a tablet, or a telephone) and stationary computing devices (for example, a desktop computer or a server). A producer, subscriber, and/or user may use the user device 278 to access the decision support system 250, review raw data, and generate analytics, overlays, and/or reports.

The trending and analysis engine 258 may include software modules configured to process data collected by the data aggregator 254 according to user requests. The software modules may be configured to compare data, overlay data, trend data, and statistically analyze data. The trending and analysis engine 258 may be configured to overlay multiple data feeds including, but not limited to, location data, fertilizer data (including without limitation identification data, flow rate data, pressure data, and/or temperature data), market data (including without limitation commodity price data), regulatory data, seed data, soil data, weather data, yield data, and any other suitable data. The data may include historical, recent, and/or real-time data. In one example, the trending and analysis engine 258 may overlay position data (for example, GPS data), fertilizer data, and yield data to determine reasons for varying yields within a field.

The trending and analysis engine 258 may be used to determine, for example, flow rate, pressure, and/or temperature thresholds for input into the software control unit 114. The decision support system 250 may be configured to calculate these thresholds prior to liquid fertilizer application and/or real-time during liquid fertilizer application. For example, prior to liquid fertilizer application, a user may access the decision support system 250 to determine various thresholds and then manually enter the thresholds into the software control unit 114 or have the decision support system 250 automatically transmit the thresholds to the software control unit 114. Additionally or alternatively, during liquid fertilizer application, the decision support system 250 may adjust the thresholds associated with the software control unit 114 based on real-time data received from the software control unit 114, such as soil moisture content and weather conditions. The analysis engine 258 may be hardware, software configured to be executed by a processor, or a combination of both.

The output or report generator 262, which may be referred to as a module, may be configured to process report requests. Reports may include, for instance, analysis, overlay, trending, and/or regulatory reports. The reports may be configured to assist producers, fertilizer companies, original equipment manufacturers, seed companies, and/or other users in making business decisions. Additionally or alternatively, the reports may be configured to assist users in complying with government regulations. For example, the report generator 262 may be configured to use fertilizer data (including amount, location, type, weather conditions, and/or other pertinent information) collected by the data aggregator 254 and generate environmental reports complying with reporting requirements. In one implementation, a report includes exact liquid usage and placement to comply with government regulations, such as the U.S. Environmental Protection Agency (EPA). The report generator 262 may provide the requested report to the requestor and/or to the associated government agency. The output or report generator 262 may be hardware, software configured to be executed by a processor, or a combination of both.

The support system database 266 may be configured to store data collected by the data aggregator 254, trending and analysis data generated by the trending and analysis engine 258, and reports processed by the report generator 262. The support system database 266 also may store overlay, trending, and/or report templates to reduce processor burdens in generating overlays, trending charts, and/or reports. For example, the support system database 266 may store report templates for each city, county, state, and/or federal reporting agency with select fields configured to be populated by the report generator 262. The support system database 266 may be a relational database that is adapted to store, update, and retrieve data in response to formatted commands, for example.

The decision support system 250 may be associated with one or more server computers. For example, the decision support system 250 may be associated with a web server, which may be used to process requests from the user device 278. The one or more server computers may include a conventional operating system and may be capable of executing programs or scripts in response to the user device 278, for example. As one example, the one or more server computers may execute one or more web applications. The one or more web applications may be implemented as one or more scripts or programs written in any programming language, scripting language, and/or combinations thereof. The one or more server computers may include storage devices, such as a disk drive, an optical storage device, a solid-state storage device (for example a random access memory and/or a read-only memory). The one or more server computers may include a processor configured or operable to execute computer-readable instructions.

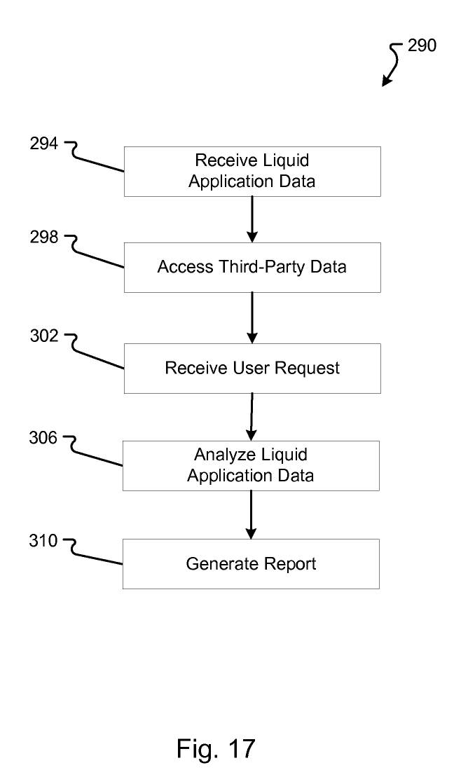

FIG. 17 provides a method 290 of an example operation of the decision support system 250. At operation 294, the decision support system 250 receives liquid application data, which may be performed by a data aggregator 254. The liquid application data may be received from a user (such as a producer). The operation 294 may include receiving fertilizer data (such as composition, density, flow rate, pressure, temperature, volume, and/or other suitable fertilizer characteristics) associated with a liquid application to a field. Additionally or alternatively, the operation 294 may include receiving location data (such as GPS coordinates) associated with a liquid application to a field. The location data may indicate where and how much liquid was placed on a row-by-row basis (such as ounces per minute per row). Additionally or alternatively, the operation 294 may include receiving tractor or vehicle data (such as direction, speed, and/or other suitable vehicle characteristics) associated with a liquid application to a field. Additionally or alternatively, the operation 294 may include receiving seed data (such as application rate, type, variety, and/or other suitable seed characteristics) associated with a liquid application to a field. Additionally or alternatively, the operation 294 may include receiving soil data (such as soil moisture content, pH, type, and/or other suitable soil characteristics) associated with a liquid application to a field. The soil data may be sampled prior to liquid application, during liquid application, and/or after liquid application to a field. Additionally or alternatively, the operation 294 may include receiving weather conditions (such as humidity, temperature, wind direction, wind speed, and/or other suitable weather characteristics) associated with a liquid application to a field. The weather conditions may be prior to liquid application, during liquid application, and/or after liquid application to a field.

At operation 298, the decision support system 250 accesses a third-party data, which may be performed by a data aggregator 254. The operation 298 may include accessing a fertilizer database, which may be used to obtain additional information on an applied fertilizer and/or to compare an applied fertilizer to other fertilizer options. Additionally or alternatively, the operation 298 may include accessing a seed database, which may be used to obtain additional information on an applied seed and/or to compare an applied seed to other seed options. Additionally or alternatively, the operation 298 may include accessing a soil-sampling database, which may be used to obtain additional information on a field soil sample and/or to compare a field soil sample to other soil samples. Additionally or alternatively, the operation 298 may include accessing a weather database, which may be used to obtain additional weather information related to a field application and/or to compare the weather associated with a field application to weather conditions in other field applications. Additionally or alternatively, the operation 298 may include accessing a yield database, which may be used to obtain additional yield information associated with a liquid application and/or to compare yields associated with different field applications. The operation 298 may access, collect, and/or store third-party data for use as historical data in analyzing (such as comparisons, overlays, statistics, trends, and/or other suitable analytics) a select field application to other field applications. The operation 298 may access, collect, and/or store third-party data automatically and/or in response to a user request.

At operation 302, the decision support system 250 receives a user request, which may be received from a user device 278. The user request may include raw data requests, analysis requests, report requests, and/or other requests. Upon receiving the request, the decision support system 250 may perform the requested action and provide the user with the requested information. The requested information may be transmitted to the user device directly, accessible by the user device (such as being stored remotely on a web server accessible by the user device), and/or other suitable methods.

At operation 306, the decision support system 250 analyzes liquid application data, which may be performed in response to receiving a user request. The operation 306 may include comparing harvest yield data with liquid application data and/or third-party data to determine reasons for varying yields within a given field, for example. The operation 306 may use fertilizer data, location data, seed data, soil data, vehicle data, weather data, and/or other data to determine causes for varying yields. As one example, the operation 306 may analyze wind variance to account for fertilizer drift within a given field or into adjacent fields that may cause yield issues for producers. Additionally or alternatively, the operation 306 may analyze vehicle speed to account for fertilizer drift, as certain fertilizers should be applied at certain speeds to minimize or reduce drift.

At operation 310, the decision support system 250 generates a report, which may be selected by a user. A report may be presented in different formats, including visual (such as a chart, a graph, an overlay, and/or other visual formats) and/or textual (such as a paragraph, a table, and/or other textual formats). As one non-limiting example, a user may request a report in the form of an overlay visually depicting yield data with liquid application data and/or third-party data. As another non-limiting example, a user may request a report of liquid application data to comply with government regulations. A report may include various data. For example, a report may include yield data, field application data (such as fertilizer data, location data, vehicle speed data, seed data, soil data, weather data, and/or other application data), and/or third-party data (such as yield data, fertilizer data, vehicle speed data, seed data, soil data, weather data, and/or other application data). This may allow a user to compare yield data to field application data for a given field to determine variances within the given field. Additionally or alternatively, a user may compare data from a given field to data obtained from other fields (which may be owned by third parties) to determine changes the user may implement to improve yield results. As an example, a user may a particular type of fertilizer, application rate, pressure, and/or temperature achieved better yield results for a given type of soil. In some implementations, a user may input determined characteristics (such as seed type, soil type, soil pH, weather, etc.) and the decision support system 250 may calculate the undetermined characteristics (such as fertilizer type, flow rate, pressure, temperature, etc.) to maximize yield. The method 290 may be configured as instructions stored on a non-transitory computer readable storage medium and configured to be executed by a processor.

As described, a liquid application monitoring system is provided. The system may manage, monitor, and/or track liquid fertilizer applications. For instance, the liquid management system may track the amount of liquid applied to a field (for example the liquid volume), the location or placement of liquid applied to a field (for example with GPS coordinates), the flow rate, pressure, temperature, and/or type of liquid applied to a field (for example with a sensor associated with a flow meter), the time of liquid application, and/or other application characteristics. The system also may record the data for later analysis and/or processing. For instance, the system may store liquid fertilizer application records for later analysis and/or processing.

The example systems and methods may improve the monitoring of liquid fertilizer application from agricultural equipment, sprayers, and implements, for example. The systems and methods may provide users with an automated monitoring system that may inform users (via monitoring devices such as sensors and flow meters) when and if a liquid fertilizer tube or row unit is plugged. Additionally or alternatively, the systems and methods may provide on-demand flow rates (such as gallons per minute, gallons per acre, and/or ounces per minute), on-demand liquid temperature, and other calculable metrics. The systems and methods may provide individual flow or rate monitoring on an unlimited row by row basis. This capability provides specific diagnostics, data management, and data metrics over fertilizer or liquid application for each row or unit. By providing insight into the flow, rate, and/or other characteristics during liquid application, the systems and methods may increase crop yields without the risk of under- or over-application of fertilizer. In addition to effecting crop production, better liquid application oversight may also positively effect fertilizer environmental concerns, such as water contamination.

Additionally, the example systems and methods may support the capturing and analyzing of liquid application data via a hosted web solution. The systems and methods may overlay the application data with information from multiple sources (such as fertilizer data, location data, market data, seed data, soil data, weather data, and/or other data). That is, the systems and methods may collect and process data from a number of disparate data sources. The analyzed data may facilitate a more informed producer, and result in improved yields and reduced fertilizer runoff due to appropriate fertilizer amounts and placement. For example, the example systems and methods may provide the producer with data metrics that allow the producer to adjust fertilizer amounts and/or placements based on various factors, including yield. The systems and methods also may provide the producer with detailed reports directed to assisting the producer make more informed farming decisions and/or to comply with government regulations and/or restrictions.

All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other.

In some instances, components are described with reference to “ends” having a particular characteristic and/or being connected with another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A fertilizer decision support system, comprising:
a data aggregator configured to receive, from an electronic device, data relating to the application of a liquid fertilizer to a field having a number of rows, the data comprising at least one fertilizer characteristic and yield data relating to each row of the number of rows;
an analysis engine in communication with the data aggregator and configured to compare the at least one fertilizer characteristic and the yield data for each row of the number of rows; and
an output generator in communication with the analysis engine and configured to communicate the results of the comparison to a user.

2. The system of claim 1, further comprising
a memory configured to receive the at least one fertilizer characteristic and the yield data from the data aggregator and store the at least one fertilizer characteristic and the yield data; and
a processor in communication with the memory, wherein the data aggregator, the analysis engine, and the output generator are software configured to be executed by the processor.

3. The system of claim 2, wherein the at least one fertilizer characteristic comprises a flow rate of the liquid fertilizer.

4. The system of claim 3, wherein the at least one fertilizer characteristic further comprises a pressure of the liquid fertilizer.

5. The system of claim 4, wherein the at least one fertilizer characteristic further comprises a temperature of the liquid fertilizer.

6. The system of claim 2, wherein
the data further comprises tractor speed data relating to each row of the number of rows,
the analysis engine is configured to compare the at least one fertilizer characteristic, the yield data, and the tractor speed data for each row of the number of rows.

7. The system of claim 2, wherein
the data further comprises seed data relating to each row of the number of rows, and
the analysis engine is configured to the at least one fertilizer characteristic, the yield data, and the seed data for each row of the number of rows.

8. The system of claim 2, wherein
the data further comprises soil data relating to each row of the number of rows, and
the analysis engine is configured to compare the at least one fertilizer characteristic, the yield data, and the soil data for each row of the number of rows.

9. The system of claim 2, wherein
the data aggregator is configured to receive third-party data, and
the analysis engine is configured to compare the at least one fertilizer characteristic, the yield data, and the third-party data for each row of the number of rows.

10. The system of claim 2, wherein the output generator is configured to format the results of the comparison as an overlay.

11. A method for supporting fertilizer decisions, comprising:
receiving, from an electronic device, data relating to the application of a liquid fertilizer to a field having a number of rows, the data comprising at least one fertilizer characteristic and yield data relating to each row of the number of rows;
receiving, from an electronic device, a request from a user to analyze the data;
comparing, by a processor, the at least one fertilizer characteristic and the yield data for each row of the number of rows; and
communicating the results of the comparison to the user.

12. The method of claim 11, wherein the at least one fertilizer characteristic comprises a flow rate of the liquid fertilizer.

13. The method of claim 12, wherein the at least one fertilizer characteristic further comprises a pressure of the liquid fertilizer.

14. The method of claim 13, wherein the at least one fertilizer characteristic further comprises a temperature of the liquid fertilizer.

15. The method of claim 11, wherein the data further comprises tractor speed data relating to each row of the number of rows, and further comprising comparing, by a processor, the at least one fertilizer characteristic, the yield data, and the tractor speed data for each row of the number of rows.

16. The method of claim 11, wherein the data further comprises seed data relating to each row of the number of rows, and further comprising comparing, by a processor, the at least one fertilizer characteristic, the yield data, and the seed data for each row of the number of rows.

17. The method of claim 11, wherein the data further comprises soil data relating to each row of the number of rows, and further comprising comparing, by a processor, the at least one fertilizer characteristic, the yield data, and the soil data for each row of the number of rows.

18. The method of claim 11, wherein the data further comprises weather data, and further comprising comparing, by a processor, the at least one fertilizer characteristic, the yield data, and the weather data for each row of the number of rows.

19. The method of claim 11, further comprising
receiving third-party data; and
comparing, by a processor, the at least one fertilizer characteristic, the yield data, and the third-party data for each row of the number of rows.

20. The method of claim 11, further comprising overlaying the at least one fertilizer characteristic and the yield data for each row of the number of rows.

21. The method of claim 11, further comprising formatting the results of the comparison as a report complying with a governmental fertilizer regulation.

22. A liquid fertilizer system, comprising:
a fluid bar fluidly connected to a fertilizer source, the fluid bar capable of attachment to a farm machine and including a fluid passageway that is in fluid communication with a plurality of apertures; and
a plurality of sensors operably associated with the fluid bar, each sensor of the plurality of sensors configured to detect an identifying characteristic of a fluid flowing from the fluid passageway to at least one aperture of the plurality of apertures.

23. The system of claim 22, wherein each sensor of the plurality of sensors is configured to detect an elemental composition of the liquid.

24. The system of claim 22, wherein each sensor of the plurality of sensors is configured to detect an identifier added to the fluid.

25. The system of claim 22, further comprising a fluid reservoir in fluidic communication with the fluid bar to capture a sample of the fluid as it flows from the fluid passageway to the at least one aperture of the plurality of apertures.

26. The system of claim 25, wherein the fluid reservoir includes a plurality of storage cells.

27. The system of claim 22, further comprising a sensor monitor in communication with the plurality of sensors and configured to display for each sensor of the plurality of sensors the characteristic of the fluid measured by the sensor.
